(19) United States
(12) Patent Application Publication
(10) Pub. No.: US 2009/0301317 A1
(43) Pub. Date: Dec. 10, 2009

(54) Method and System for Dispensing Whipped Toppings

(75) Inventor: Cecil Andrews, Austin, TX (US)

Correspondence Address: DUBOIS, BRYANT, CAMPBELL & SCHWARTZ, LLP, 700 LAVACA STREET, SUITE 1300, AUSTIN, TX, 78701, US

(73) Assignee: EIEIO, INC., Austin, TX (US)

(21) Appl. No.: 12/200,469

(22) Filed: Aug. 28, 2008

Related U.S. Application Data
(60) Provisional application No. 61/058,772, filed on Jun. 4, 2008.

(51) Int. Cl. A23C 3/02; B23P 11/00

(52) U.S. Cl. 99/453; 29/428

(57) ABSTRACT

A method and system for automatically producing and dispensing a whipped product, such as edible whipped cream, is provided. In one embodiment, the system includes a mixture bag containing an input mix, a check valve which allows air to comingle with the input mix, a peristaltic pump which moves the input mix and air into a whipping rod housing, a whipping rod which whips the input mix and air in the whipping rod housing to form a whipped product, and a dispensing mechanism for dispensing the whipped product. Such system components may also be housed within or in close proximity to a refrigeration compartment. In addition, the system may also include a warning function and display device to provide notice of when the system's input mix levels are low or when other maintenance may be required.

### CROSS-REFERENCE TO RELATED APPLICATIONS

This non-provisional application claims priority based upon prior U.S. Provisional Patent Application Ser. No. 61/058,772 filed Jun. 4, 2008 in the name of Cecil Andrews, entitled “Method and System for Dispensing Whipped Toppings,” the disclosure of which is incorporated herein by reference.

### BACKGROUND OF THE INVENTION

The present invention relates generally to a system and method for making and dispensing a whipped product and, more particularly, to a system and method for automatically making and dispensing an edible whipped product on demand.

Whipped cream is a widely popular culinary accent that can transform everyday food and beverages, such as desserts and coffees, into exceptional and delightful treats. Nevertheless, production of whipped cream has long been a labor intensive and difficult process. For example, whipped cream has a limited shelf life, will rapidly spoil without sufficient refrigeration, and naturally begins to separate into liquid and air components only a short time period after it is whipped into a foamy state. As a result, systems known in the art that assist whip cream production have been plagued by sanitation and quality issues.

To address sanitation, systems known in the art require extensive manual cleaning to ensure that mixing, whipping, and pump equipment, tubing and containers, and dispensing mechanisms are properly sanitized. Typically, such extensive cleaning is necessary on at least a daily basis to ensure a minimum level of acceptable sanitation.

The dispensing mechanisms of systems known in the art are particularly susceptible to sanitation risks because such dispensing mechanisms employ a tip that often extends below the refrigerated sections of the system, often up to six inches or so. Consequently, such dispensing mechanisms are exposed to ambient temperature and air and pose a significant risk for bacterial growth unless such dispensing mechanisms are either continuously dispensing whipped cream or consistently cleaned between each intermittent use. This sanitation risk increases dramatically as the temperature of the dispensing mechanism increases above 40 degrees Fahrenheit.

Systems known in the art also fail to consistently produce whipped product that is of a consistently high quality. For example, consistent production of a homogenous whipped product requires a careful choice and balancing of variables such as whipping speed, input mix ingredients, the ratio of air to whipping mixture, temperature, and pressure. An improper whipping speed, for instance, can create a whipped product with a texture that is too stiff or that is not adequately foamed. Similarly, improper temperature or pressure can lead to an unstable whipped product with foam that rapidly separates. Quality issues may become particularly prevalent when system pressure and air ratios change as a result of a low level of input mix in a machine's input mix supply reservoir.

As an alternative to systems known in the art, commercial establishments and consumers sometimes purchase disposable whipped cream dispensing cartridges. Such cartridges combine a cream mixture with an aerosol propellant of high pressured nitrous oxide. These cartridges, however, present a number of problems. For example, the cartridges are expensive, particularly when considered on a product volume per dollar of cost basis, and disposal of used cartridges creates unnecessary waste. In addition, commercial establishments often have trouble ensuring the proper refrigeration of such cartridges. For instance, commercial establishments desiring to provide customers with direct access to such cartridges must provide a refrigerator unit that is accessible to customers and must also monitor the length of time that the cartridges are removed from refrigeration. Otherwise, the cartridges' highly perishable contents may spoil. Whipped cream dispensing cartridges have also been heavily criticized as a readily available source of nitrous oxide inhalant for adolescent drug users.

Despite the promoted efficiency of the methods and systems known in the art, many are impracticable from the commercial point of view for the reasons set forth above. Therefore, in appreciation of the popularity of whipped cream as a topping for multiple food and beverages, it can be appreciated that there is a significant need for a system and method that will produce and dispense a commercially feasible whipped product (i) in a sanitary manner without requiring a significant amount of cleaning or monitoring of refrigeration, (ii) that is of a consistently high quality, and (iii) that avoids use of waste producing cartridges and potentially harmful nitrous oxide gas. The present invention provides these and other advantages, as will be apparent from the following detailed description and accompanying figures.

### BRIEF SUMMARY OF THE INVENTION

A system and method which implements a preferred embodiment of the present invention includes a means for automatically producing and dispensing a whipped product, such as edible whipped cream. In one embodiment, the present invention includes a mixture bag containing an input mix, a check valve which allows air to comingle with the input mix, a peristaltic pump which moves the input mix and air into a whipping rod housing, a whipping rod which whips the input mix and air in the whipping rod housing to form a whipped product, and a dispensing mechanism for dispensing the whipped product. Such components may also be housed within or in close proximity to a refrigeration compartment. In addition, embodiments of the present invention may also include a warning function and display device to provide notice of when the system's input mix levels are low or when other maintenance may be required. It should be appreciated that the present invention is equally applicable to the processing of a wide variety of products and formulations. It should also be appreciated that numerous industries, products, and services may benefit from the teachings contained herein.

### BRIEF DESCRIPTION OF THE DRAWINGS

FIG. 1 is an illustration of a refrigeration dispensing unit of a system that includes components to implement a preferred embodiment of the present invention;

FIG. 2 is an illustration of the refrigeration compartment of a system that includes components to implement a preferred embodiment of the present invention;

FIG. 3 is an illustration of a storage box and mixture bag of a system that includes components to implement a preferred embodiment of the present invention;

FIG. 4 is an illustration of a hose assembly of a system that includes components to implement a preferred embodiment of the present invention;

FIG. 5 is an illustration of a check valve assembly of a system that includes components to implement a preferred embodiment of the present invention;

FIG. 6 is a flowchart illustrating significant functions of the loading operation in a preferred embodiment of the present invention; and

FIG. 7 is a flowchart illustrating significant functions of the dispensing operation in a preferred embodiment of the present invention.

### DETAILED DESCRIPTION

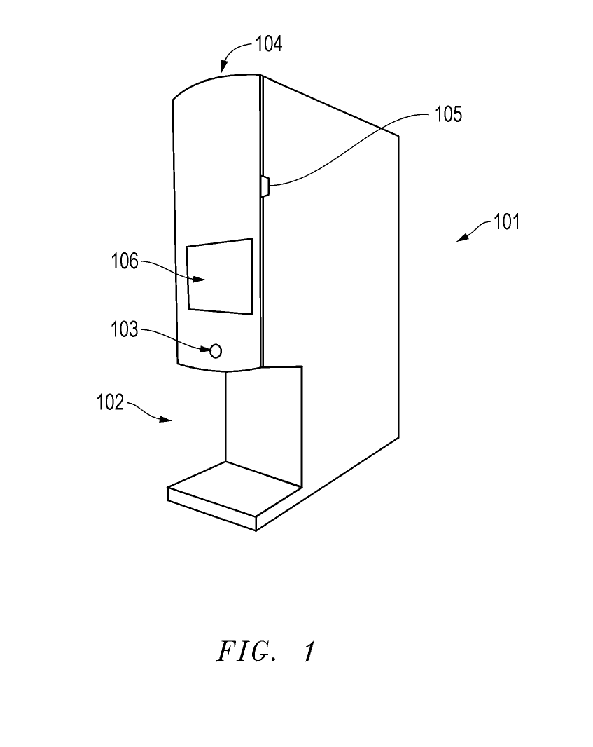

Reference is now made to FIG. 1 which is an illustration of a refrigeration dispensing unit of a system that includes components to implement a preferred embodiment of the present invention. In this embodiment, the refrigeration dispensing unit 101 has an open dispensing area 102 to receive a container, such as a cup of coffee or hot cocoa, that is to collect a whipped product. In one embodiment, a user pushes a button 103 to dispense the whipped product. In another embodiment, the whipped product is automatically dispensed after placement of the container in the open dispensing area 102. In still another embodiment, a user may choose from a number of options such as the amount of whipped product desired or from different types of whipped products, such as whipped products of different flavors or fat contents. A door 104 that is secured by a latch 105 is shown on the proximal end of the refrigeration dispensing unit 101. In this embodiment, the refrigeration dispensing unit 101 also has an audio and visual display device 106. The display device 106 may assist with the operation and maintenance of the refrigeration dispensing unit 101. For example, the display device 106 may consist of a light-emitting diode (LED) display that indicates various information and warnings such as (i) the level of input mix in the refrigeration dispensing unit, (ii) when the input mix supply of the refrigeration dispensing unit 101 is empty, running low, has expired or otherwise needs to be replaced, (iii) when maintenance of the refrigeration dispensing unit 101 is recommended or (iv) when a maximum acceptable temperature within the refrigeration compartment of the refrigeration dispensing unit 101 is exceeded.

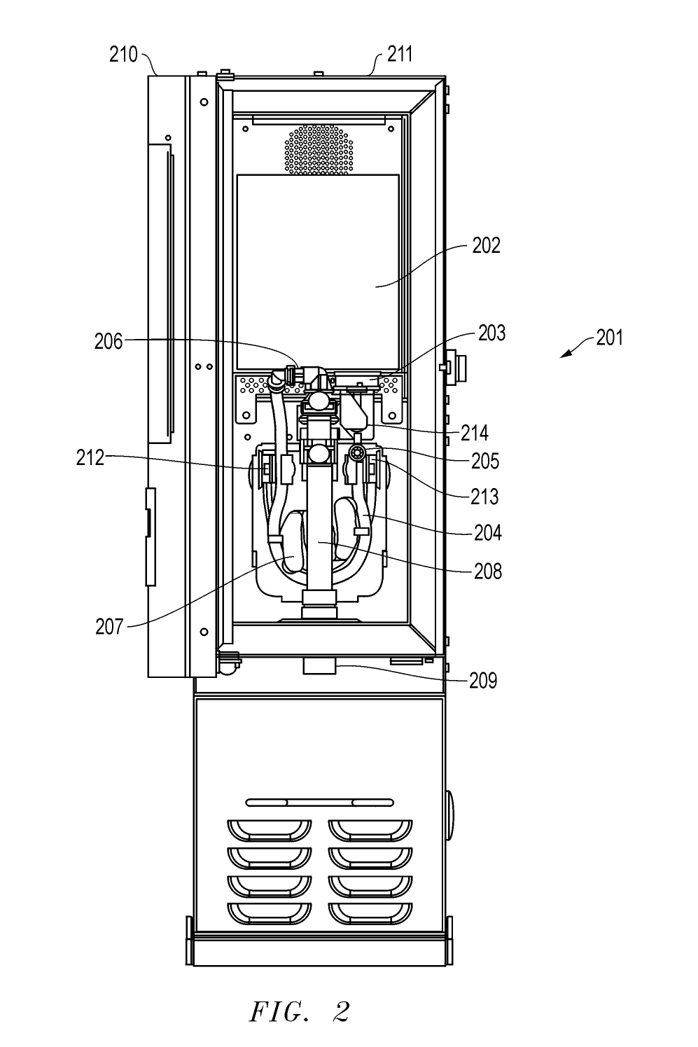

Reference is now made to FIG. 2 which is an illustration of the refrigeration compartment of a system that includes components to implement a preferred embodiment of the present invention. The door 210 on the proximal end of the refrigeration dispensing unit 201 is open, exposing the refrigeration compartment 211 of the refrigeration dispensing unit 201. A storage box 202 is shown inserted into the refrigeration compartment 211. Inside the storage box 202 is a mixture bag (not shown). The mixture bag may be filled with any material that is capable of being whipped, such as a whipped cream input mix or other dairy or non-dairy input mix or ingredients desired by a user. The material in the bag may contain fats, emulsifiers, whipping agents, sweeteners and other ingredients that may be useful in processing or may improve the taste or appearance of the finished whipped product.

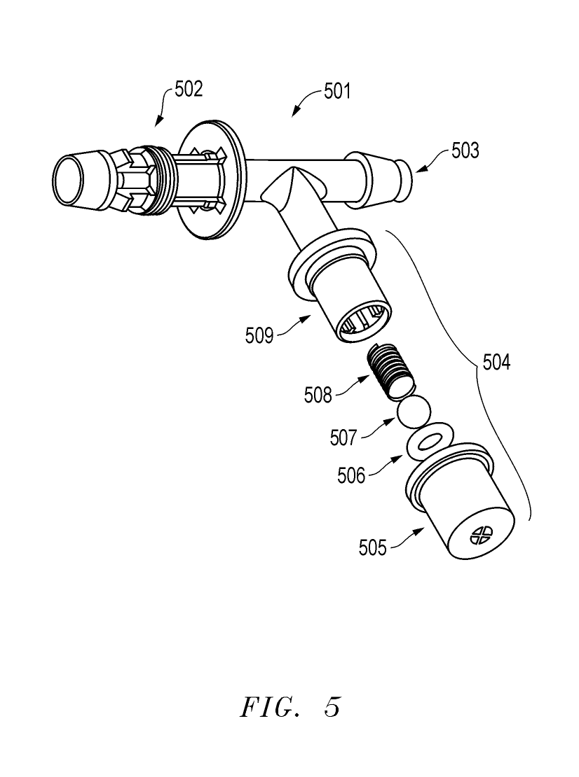

A hose assembly 204 is affixed to the mixture bag through an access hole in the storage box 202. At the proximal end of the hose assembly 204 is a check valve assembly 205. A more detailed depiction of the check valve assembly 205 is shown in FIG. 5. The check valve assembly 205 is configured so that one end of the check valve assembly 205 connects to the spout 203 of the mixture bag through an access hole in the mixture box 202. In addition, the check valve assembly 205 is fitted with an air valve that allows air to enter the hose assembly 204.

The hose assembly 204 is configured to connect to the spout 203, run through the peristaltic pump 207, and connect to a female coupling 206 of the whipping rod housing 208. As the peristaltic pump 207 rotates against the outer portion of the hose assembly 204, input mix from the mixture bag and air flowing through the air valve of the check valve assembly 205 are drawn into the hose assembly 204 and pumped to the whipping rod housing 208. In one embodiment, the air is drawn from the inside of the refrigeration compartment so that the air is at the same or similar temperature as the input mix, thereby improving the efficacy of the whipping process. The faster the peristaltic pump 207 rotates, the more the air and input mix are drawn into the hose assembly 204. In one embodiment, the flow of input mix from the mixture bag into the hose assembly 204 can be halted even as the peristaltic pump 207 rotates. For example, a solenoid 214 with a retractable tip can be engaged after a predetermined amount of time to effectively pinch the hose assembly 204 in the space between the connection of the hose assembly 204 to the mixture bag and the air valve on the check valve assembly 205. The rotation of the peristaltic pump 207, the dimensions of the hose in the hose assembly 204, the flow of input mix into the hose assembly 204, and the air flow through the check valve assembly 205 may be optimized to create the desired attributes of the finished whipped product.

The combination of air and input mix passing through the hose assembly 204 is directed through the whip rod assembly 208 where a whip rod within the whipped rod assembly 208 whips the combination of air and input mix from the bag into a whipped product, such as whipped cream. The whip rod is substantially contained within the refrigeration compartment 211 so as to maintain the temperature of the whip rod at 40 degrees Fahrenheit or below. In addition, the dispensing mechanism 209 of the whip rod housing 208 is in close proximity to the refrigeration compartment 211 so that the temperature of the tip of the dispensing mechanism 209 generally remains at or below 40 degrees Fahrenheit. In addition, by including the whip rod housing 208 within the refrigeration compartment 211 the majority of the whipping occurs within the refrigeration compartment, thereby improving the efficacy of the whipping process.

It is important to note that because the input mix to be whipped is processed through a contained system, the inside of the refrigeration compartment 211 and the components included within the refrigeration compartment 211 need not be cleaned on a daily basis. Typically, the components included within the refrigeration compartment 211 do not need to be cleaned more frequently than the frequency with which new storage boxes 202 with mixture bags of input mix are loaded into the refrigeration compartment 211. This provides an advantage over systems known in the art which require daily cleaning of system components.

The peristaltic pump 207 is any of a variety of such pumps known in the art. The rotational speed of the pump will vary depending upon the ingredients of the input mix being processed, the amount of air desired, the configuration of the hose assembly 204, and other factors.

Although the embodiment of the present invention that is illustrated in FIG. 2 only shows one mixture bag containing input mix, one hose assembly and one whip rod housing, it can be appreciated that, consistent with the present invention, the refrigeration dispensing unit may include more than one mixture bag each containing a different input mix, more than one hose assembly and/or more than one whip rod housing so that a user may choose between whipped products of various flavors, styles or contents.

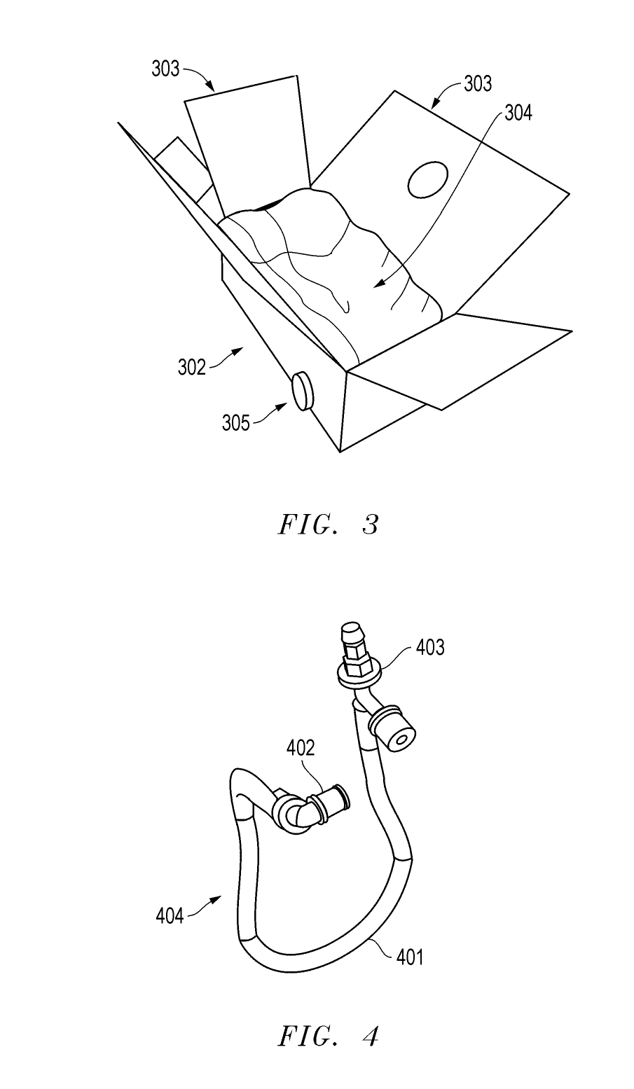

Reference is now made to FIG. 3 which is an illustration of a storage box and mixture bag of a system that includes components to implement a preferred embodiment of the present invention. The storage box 302 is shown inserted with its top flaps 303 open so that the mixture bag 304 within the storage box 302 can be seen. The storage box 302 may be made of corrugated material or any other material suitable for shipping and storing the mixture bag 304 with input mix inside. In one embodiment, the storage box is made of a recyclable cardboard material. The mixture bag may be any type of bag that is commercially available. In one embodiment, the mixture bag 304 is comprised of an aseptic material so as to preserve a sterile environment within the mixture bag 304 to prevent the contents of the mixture bag 304 from perishing. In one embodiment, the mixture bag 304 is also recyclable. The mixture bag 304 also contains a capped spout 305 on its side that is accessible through an access hole in the storage box 302. The cap may be removed from the spout 305 so that the hose assembly may be securely seated into the spout 305.

Reference is now made to FIG. 4 which is an illustration of a hose assembly of a system that includes components to implement a preferred embodiment of the present invention. The hose 401 portion of the hose assembly 404 is made of a pliable material, such as neoprene. The dimensions of the hose 401 may be any dimensions suitable for processing. In one embodiment, the interior diameter of the hose 401 is approximately 0.252 inches, the wall thickness is approximately 0.094 inches, and the length of the hose 401 is approximately 16.5 inches. In one embodiment, the hose assembly 404 is disposable or recyclable. At one end of the hose assembly 404 is a quick connect male coupling 402 which attaches to the female coupling of the whipping rod housing. At the other end of the hose assembly 404 is the check valve assembly 403.

Reference is now made to FIG. 5 which is an illustration of a check valve assembly of a system that includes components to implement a preferred embodiment of the present invention. As well, references to components shown in FIG. 2 continue to be used hereinafter. In this embodiment, a male coupling 502 is located at one end of the “T” shaped check valve assembly 501. The male coupling 502 is designed so that it may be seated and locked into the spout of the bag containing the input mix. In addition, a barbed fitting 503 is located at another end of the “T” shaped check valve assembly 501. The barbed fitting 503 is designed to allow the hose of the hose assembly to connect to the “T” shaped check valve assembly 501. Also, a check valve 504 is connected to a third end of the “T” shaped check valve assembly 501. The check valve may be of a venturi or any conventional configuration. In this simplified illustration, the components of check valve 504 are shown unassembled and include a regulator cap 505, a rubber o-ring 506, a stainless steel ball 507 that fits onto the rubber o-ring 506, a stainless steel spring 508 that pushes the ball 507 onto the rubber o-ring 506, and a check valve base 509. When the peristaltic pump 207 pulls input mix through the hose assembly 204, the check valve 504 allows cooled air from the refrigeration compartment 211 to flow through the check valve 504 into the hose assembly 204. The size of the check valve 504 and the stiffness of the stainless steel spring 508 may be chosen to reflect the size and desired rotations per minute of the peristaltic pump 207 during operation so that the amount of air flowing through the check valve 504 is in the desired proportion to the amount of input mix flowing into the hose assembly 204. The check valve 504 also prevents input mix and air that is within the hose assembly 204 from flowing out through the check valve 504 to the refrigeration compartment 211.

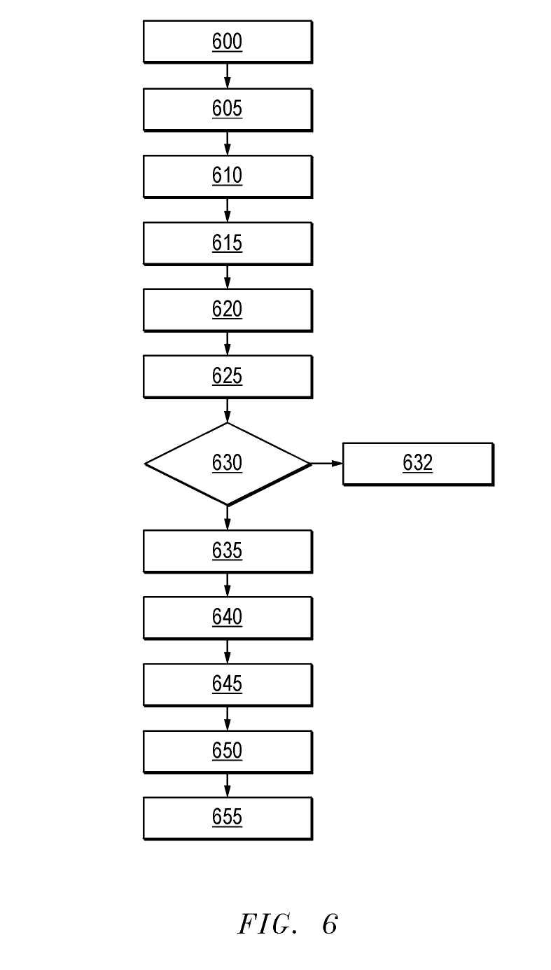

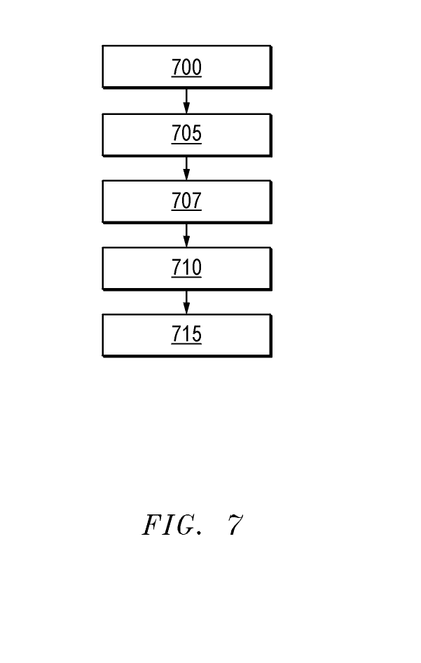

Reference is now made to FIG. 6 which is a flowchart illustrating significant functions of the loading operation in a preferred embodiment of the present invention. As well, references to components shown in previous figures continue to be used hereinafter. At a start 600, it is assumed that the refrigeration compartment 211 has reached an appropriate cooling temperature, in one embodiment, in the range of approximately 30 to 34 degrees Fahrenheit.

In step 605, an operator opens the flaps 303 of a new storage box 202 containing a mixture bag 304 of input mix, removes a packaged hose assembly 204 contained therein, and closes the flaps 303 of the storage box 202.

In step 610, the operator prepares the storage box 202 for use by locating and removing perforated sections around the sides of the storage box 202 that define access holes.

In step 615, the operator locates the spout 203 of the mixture bag 304 through an access hole in the storage box 202 and locks the spout 203 into the access hole of the storage box 202.

In step 620, the operator removes the hose assembly 204 from its packaging and removes the cap from the spout 203 of the mixture bag 304.

In step 625, the operator inserts the male coupling 502 of the “T” shaped check valve assembly 501 into the opening of the spout 203 until the male coupling 502 is securely seated and locked into place.

In step 630, the operator opens the door 104 of the refrigeration compartment 211 and determines whether a used storage box 202 (including empty mixture bag 304 contained therein) and a used hose assembly 204 are present in the refrigeration compartment 211. If such items are present, then, in step 632, the operator next removes and disposes of or recycles the used storage box 202 (including the empty mixture bag 304 contained therein) and used hose assembly 204. Otherwise, the operator continues directly to step 635.

In step 635, the operator places the new storage box 202 into the refrigeration compartment 211 with the spout 203 facing downward. In one embodiment, the operator writes date information on the storage box 202 to indicate information such as the date the new storage box 202 was loaded into the refrigeration compartment 211 and the date the new storage box 202 should be removed from the refrigeration compartment 211 to ensure that input mix from the mixture bag 304 within the storage box 202 is not used after the shelf life of the input mix has expired.

In step 640, the operator threads the hose 401 of the hose assembly 204 through the peristaltic pump 207. In one embodiment, the hose 401 may be threaded by opening a first pinch clip 213 located along a slot for the hose 401 that is approximately below the spout 203. The hose 401 is next placed into the slot and is threaded around the peristaltic pump 207 by manually turning the peristaltic pump 207 in a clockwise direction. The operator may then open a second pinch clip 212 and guide the hose 401 through a slot leading from the peristaltic pump 207 to the female coupling 206 of the whipping rod housing 208. The operator next connects the quick connect male coupling 402 of the hose assembly 204 to the female coupling 206 of the whipping rod housing 208 and closes the first pinch clip 213 and the second pinch clip 212.

In step 645, the operator closes and latches the door 104 of the refrigeration compartment 211.

In step 650, the operator places a cup into the open dispensing area 102 and depresses the button 103, generally one or two times, until whipped product dispenses.

In step 655, the operator also has the option of pressing a product reset button to reset the warning functions and/or the display device 106 of the refrigeration dispensing unit 101.

Reference is now made to FIG. 7 which is a flowchart illustrating significant functions of the dispensing operation in a preferred embodiment of the present invention. As well, references to components shown in previous figures continue to be used hereinafter. In step 700, a user using the refrigeration dispensing unit 101 places a container, such as cup of coffee or hot cocoa, into the open dispensing area 102 and pushes the button 103. In step 705, the pushed button 103 triggers the peristaltic pump 207 to rotate. The rotation of the peristaltic pump 207 draws input mix from the mixture bag 304 into the hose assembly 204 and, at the same time, draws cooled air from the refrigeration compartment 211 through the check valve assembly 205 and into the hose 401. In step 707, a solenoid 214 with a retractable tip engages, after a predetermined amount of time, to halt the flow of additional input mix into the hose assembly 204. The rotation of the peristaltic pump 207, however, continues to draw cooled air from the refrigeration compartment 211 through the check valve assembly 205 and into the hose 401. In this manner, desired amounts of the input mix and cooled air are comingled in the hose 401 and proceed through the hose assembly 204 into the whip rod housing 208. In step 710, a whip rod within the whip rod housing 208 whips the input mix and cooled air together into a whipped product of a desired consistency. In step 715, a preselected amount of the whipped product is dispensed through the dispensing nozzle 109 and into the user's container.

While the present system and method has been disclosed according to the preferred embodiment of the invention, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the invention to those particular embodiment configurations. These terms may reference the same or different embodiments, and unless indicated otherwise, are combinable into aggregate embodiments. The terms “a”, “an” and “the” mean “one or more” unless expressly specified otherwise.

When a single embodiment is described herein, it will be readily apparent that more than one embodiment may be used in place of a single embodiment. Similarly, where more than one embodiment is described herein, it will be readily apparent that a single embodiment may be substituted for that one method or device.

In light of the wide variety of possible methods for tracking referrals, the detailed embodiments are intended to be illustrative only and should not be taken as limiting the scope of the invention. Rather, what is claimed as the invention is all such modifications as may come within the spirit and scope of the following claims and equivalents thereto.

None of the description in this specification should be read as implying that any particular element, step or function is an essential element which must be included in the claim scope. The scope of the patented subject matter is defined only by the allowed claims and their equivalents. Unless explicitly recited, other aspects of the present invention as described in this specification do not limit the scope of the claims.

What is claimed is:

1. A system for dispensing a whipped product comprising:
(a) a refrigeration compartment;
(b) one or more input mixes;
(c) a check valve;
(d) a peristaltic pump;
(e) a whip rod housing;
(f) a dispensing mechanism; and
(g) wherein said one or more input mixes, said check valve, said peristaltic pump, and said whip rod housing are located in said refrigeration compartment, and said dispensing mechanism is located in, or in close proximity to, said refrigeration compartment.

2. The system of claim 1 wherein said one or more input mixes are stored in a mixture bag.

3. The system of claim 2 wherein said mixture bag is stored in a storage box.

4. The system of claim 2 further comprising a hose assembly wherein said hose assembly includes said check valve and connects to said mixture bag and said whip rod housing.

5. The system of claim 1 wherein said check valve allows cooled air from said refrigeration compartment to comingle with said one or more input mixes.

6. The system of claim 1 further comprising a dispensing area to receive an item to collect a whipped product.

7. The system of claim 1 further comprising a button for allowing a user to initiate the rotation of said peristaltic pump.

8. The system of claim 6 wherein a whipped product is automatically dispensed through said dispensing mechanism after said item is received in said dispensing area.

9. The system of claim 1 wherein said one or more input mixes contain different flavors or fat contents.

10. The system of claim 1 further comprising a display device.

11. The system of claim 1 wherein a warning is provided if at least one of the following conditions is satisfied: the level of at least one of said one or more input mixes is low, at least one of said one or more input mixes has expired or the temperature of said refrigeration compartment exceeds a predetermined maximum temperature.

12. The system of claim 10 wherein said display device indicates the level of said one or more input mixes.

13. The system of claim 4 wherein said mixture bag and said hose assembly are disposable or recyclable.

14. The system of claim 1 wherein said one or more input mixes contain diary or non-dairy ingredients for making a whipped cream.

15. The system of claim 1 wherein said one or more input mixes contains at least one of the following: fats, emulsifiers, whipping agents, sweeteners.

16. The system of claim 4 wherein said connection between said hose assembly and said mixture bag involves connecting a coupling on said hose assembly to a spout on said mixture bag.

17. The system of claim 4 wherein said peristaltic pump rotates and said rotation draws cool air from said refrigeration compartment into said hose assembly, draws at least one of said one or more said input mixes into said hose assembly, and pumps the contents of said hose assembly into said whip rod housing.

18. The system of claim 17 further comprising a solenoid that may be engaged to halt said draw of at least one of said one or more said input mixes into said hose assembly.

19. The system of claim 1 wherein said dispensing mechanism is generally maintained at a temperature at or below 40 degrees Fahrenheit.

20. The system of claim 2 wherein said mixture bag is made of an aseptic material.

21. The system of claim 4 further comprising more than one said mixture bag and more than one said hose assembly.

22. The system of claim 5 wherein the ability of said check valve to regulate the flow of said air into said hose assembly, the inside diameter of said hose assembly, the size of said peristaltic pump, and the range of the rotations per minute of said peristaltic pump during operation are chosen to achieve a desired proportion of said air to said one or more input mixes in said whip rod housing.

23. A method for dispensing a whipped product comprising:
(a) cooling an input mix, air, a dispensing mechanism, a peristaltic pump, and a whip rod housing in, or in close proximity to, a refrigeration compartment;
(b) initiating the rotation of said peristaltic pump, wherein said rotation moves at least a portion of said input mix and at least a portion of said air into said whip rod housing;
(c) whipping the contents of said whipped rod housing; and
(d) at least partially dispensing said contents through said dispensing mechanism.

24. The method of claim 23 wherein said input mix is stored in a mixture bag.

25. The method of claim 24 wherein said mixture bag is stored in a storage box.

26. The method of claim 24 wherein a hose assembly is connected to said mixture bag and said whip rod housing.

27. The method of claim 26 wherein said hose assembly includes a check valve.

28. The method of claim 27 wherein said rotation of said peristaltic pump moves at least a portion of said air from said refrigeration compartment, through said check valve, and into said hose assembly in connection with said movement of said at least a portion of said air into said whip rod housing.

29. The method of claim 23 further comprising receiving an item to collect a whipped product approximately under said dispensing mechanism.

30. The method of claim 23 wherein said initiating the rotation of said peristaltic pump is accomplished by pushing a button.

31. The method of claim 23 wherein said initiating the rotation of said peristaltic pump is accomplished by placing an item approximately under said dispensing mechanism.

32. The method of claim 23 wherein said input mix consists of more than one input mix and said more than one input mix contains different flavors or fat contents.

33. The method of claim 23 wherein said input mix contains diary or non-dairy ingredients for making a whipped cream.

34. The method of claim 23 wherein said input mix contains at least one of the following: fats, emulsifiers, whipping agents, sweeteners.

35. The method of claim 23 further comprising displaying the level of said input mix.

36. The method of claim 23 further comprising warning if at least one of the following conditions is satisfied: the level of said input mix is low, said input mix has expired or the temperature of said refrigeration compartment exceeds a predetermined maximum temperature.

37. The method of claim 23 further comprising displaying whether said input mix needs to be replaced.

38. The method of claim 26 wherein said mixture bag and said hose assembly are disposable or recyclable.

39. The method of claim 26 wherein said connection between said hose assembly and said mixture bag involves connecting a coupling on said hose assembly to a spout on said mixture bag.

40. The method of claim 26 wherein said rotation of said peristaltic pump moves at least a portion of said input mix from said mixture bag and into said hose assembly in connection with said movement of said at least a portion of said input mix into said whip rod housing.

41. The method of claim 23 wherein said dispensing mechanism is generally maintained at a temperature at or below 40 degrees Fahrenheit.

42. The method of claim 24 wherein said mixture bag is made of an aseptic material.

43. The method of claim 26 further comprising more than one said input mix, more than one said mixture bag, and more than one said hose assembly.

44. The method of claim 28 wherein the ability of said check valve to regulate the flow of said air into said hose assembly, the inside diameter of said hose assembly, the size of said peristaltic pump, and the range of the rotations per minute of said peristaltic pump during operation are chosen to achieve a desired proportion of said air to said input mix in said whip rod housing.

45. The method of claim 23 wherein said movement of at least a portion of said input mix is halted after a predetermined amount of time.

46. A method for loading a refrigeration dispensing unit for dispensing whipped product comprising:
(a) connecting a first end of a hose assembly to a mixture bag wherein said mixture bag contains an input mix;
(b) placing said mixture bag and said hose assembly into a refrigeration compartment;
(c) threading a portion of said hose assembly through a peristaltic pump located in said refrigeration compartment;
(d) connecting a second end of said hose assembly to a whip rod housing located in said refrigeration compartment;
(e) closing a door to said refrigeration compartment; and
(f) triggering the rotation of said peristaltic pump.

47. The method of claim 46 wherein said mixture bag is stored in a storage box.

48. The method of claim 46 wherein said hose assembly includes a check valve.

49. The method of claim 48 wherein said rotation of said peristaltic pump moves air from said refrigeration compartment, through said check valve, and into said hose assembly, wherein said rotation of said peristaltic pump also moves said input mix from said mixture bag into said hose assembly, and wherein said rotation of said peristaltic pump further moves said air and said input mix in said hose assembly to said whip rod housing.

50. The method of claim 46 wherein said triggering involves placing an item to collect a whipped product approximately under a dispensing mechanism.

51. The method of claim 46 wherein said triggering involves by pushing a button.

52. The method of claim 46 wherein said input mix consists of more than one input mix and said more than one input mix contains different flavors or fat contents.

53. The method of claim 46 wherein said input mix contains diary or non-dairy ingredients for making a whipped cream.

54. The method of claim 46 wherein said input mix contains at least one of the following: fats, emulsifiers, whipping agents, sweeteners.

55. The method of claim 46 further comprising displaying information regarding said loading.

56. The method of claim 46 wherein said loading is initiated by a warning that at least one of the following conditions has been satisfied: the level of said input mix is low, said input mix has expired or the temperature of said refrigeration compartment exceeds a predetermined maximum temperature.

57. The method of claim 46 wherein said mixture bag and said hose assembly are disposable or recyclable.

58. The method of claim 46 wherein said connection between said hose assembly and said mixture bag involves connecting a coupling on said hose assembly to a spout on said mixture bag.

59. The method of claim 50 wherein said dispensing mechanism is generally maintained at a temperature at or below 40 degrees Fahrenheit.

60. The method of claim 46 wherein said mixture bag is made of an aseptic material.

61. The method of claim 46 further comprising more than one said input mix, more than one said mixture bag, and more than one said hose assembly.

62. The method of claim 49 wherein the ability of said check valve to regulate the flow of said air into said hose assembly, the inside diameter of said hose assembly, the size of said peristaltic pump, and the range of the rotations per minute of said peristaltic pump during operation are chosen to achieve a desired proportion of said air to said input mix in said whip rod housing.
